(19) United States
(12) Patent Application Publication
(10) Pub. No.: US 2006/0062380 A1
(43) Pub. Date: Mar. 23, 2006

(54) Method and apparatus for canceling acoustic echo in a mobile terminal

(75) Inventors: Gang-Youl Kim, Suwon-si (KR); Sang-Ki Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/228,431

(22) Filed: Sep. 19, 2005

(30) Foreign Application Priority Data
Sep. 20, 2004 (KR) 2004-0075261

(51) Int. Cl. H04M 9/08

(52) U.S. Cl. 379/406.01

(57) ABSTRACT

A method and apparatus for canceling an acoustic echo in a mobile terminal involving an acoustic echo canceller (AEC) for canceling an echo signal from a received far-end user's signal. Upon detecting double talk, a down-sampler lowpass-filters an output signal and down-samples the lowpass-filtered signal. The AEC estimates an echo signal using the far-end user's signal, and outputs a residual echo signal by canceling the estimated echo signal from the down-sampled signal. An up-sampler up-samples the residual echo signal by zero padding, and lowpass-filters the up-sampled signal.

### PRIORITY

This application claims the benefit under 35 U.S.C. § 119(a) of a Korean Patent Application entitled “Method and Apparatus for Canceling Acoustic Echo in a Mobile Terminal” filed in the Korean Intellectual Property Office on Sep. 20, 2004 and assigned Serial No. 2004-75261, the entire contents of which are hereby incorporated by reference.

### BACKGROUND OF THE INVENTION

1. Field of the Invention

The present invention relates generally to an acoustic echo cancellation method and apparatus. In particular, the present invention relates to a method and apparatus for canceling echo signals generated during a call in a mobile terminal of a mobile communication system.

2. Description of the Related Art

In general, the term “acoustic echo” refers to a phenomenon in which a sound wave originated from a sound source is reflected by a surface of an object and returned to the sound source. An example of the acoustic echo, which can be often found in the everyday life, comprises an echo with single reflection. A direct sound is opposed to the acoustic echo. The term “direct sound” refers to a directly heard sound without being reflected by the surface of an object. In other words, the acoustic echo indicates a reflected sound that arrives about 0.05 or longer second behind the direct sound in terms of the hearing sense. Therefore, the echo sound and the direct sound are heard with a time difference. In the place with multiple reflecting surfaces, such as a room and a cave, the reflection is repeated several times in various directions, for generating a complex echo sound. This is an example of a multiple reflection echo, also known as a reverberation.

Currently, with the development in communication technology, the communication system is evolving from a wired communication system into a wireless communication system. In order to provide a convenient call environment, there has been proposed a hands-free technique in which a user talks over the phone by using a microphone and a speaker instead of the earpiece and mouthpiece. The hands-free technique is applicable to a car hands-free phone, a remote conference system, a speaker-phone system, an International Mobile Telecommunication 2000 (IMT-2000) phone, and so on.

In the communication system where voice communication between the user and the communication device is performed through the speaker and the microphone, it is necessary to take into consideration the fact that a part of the voice or acoustic sound output from the speaker is input to the microphone. Therefore, the acoustic echo component should be taken into account to provide a smooth call. In a full-duplexing hands-free voice communication system, if the acoustic echo component is not appropriately canceled, a far-end user hears back his/her own voice after a lapse of a predetermined time, together with a voice of a near-end user. In other words, the user experiences an echo phenomenon during a call, feeling displeasure and inconvenience.

The acoustic echo occurs because a far-end user's signal output from the speaker is input to the microphone via an acoustic echo path, together with a noise, and then transmitted back to the far-end user. As a result, the far-end user receives the undesired echo signal along with the near-end user's signal. This phenomenon is called a howling phenomenon in communication engineering. An influence of the echo signal increases with intensity and delay time of the echo signal.

The acoustic echo path of the echo signal undergoes a frequent change with the passage of time when a mobile terminal operates not only in a normal voice call mode but also in a video conference mode or a speaker phone mode. For example, the acoustic echo path undergoes a change even when a participant of the conference moves his/her head, arm and shoulder during the video conference.

Therefore, the current mobile terminal uses an acoustic echo canceller (AEC) to cancel the echo phenomenon. The AEC estimates an echo component of a far-end user's signal by using an adaptive algorithm, and subtracts the estimated echo component from a signal input to the microphone.

The adaptive algorithm is used because a voice signal, which is the typical input signal of the AEC, has a very high inter-sample correlation and a non-static statistical characteristic. Therefore, the AEC must be implemented using the adaptive algorithm in which filter coefficients undergo a change according to the surrounding environment.

Therefore, the AEC uses an adaptive filtering technique that estimates an echo signal by estimating a time-varying acoustic echo path. The adaptive filtering technique popularly uses a normalized least mean square (NLMS) algorithm for simple structure and stable convergence.

With reference to FIGS. 1 and 2, a description will now be made of the NLMS algorithm-based AEC included in the conventional mobile terminal.

FIG. 1 is a block diagram of a conventional AEC apparatus included in a mobile terminal. A structure and operation of the conventional AEC apparatus will now be described below with reference to FIG. 1.

FIG. 1 illustrates an AEC apparatus and its peripheral circuit included in the mobile terminal. The peripheral circuit comprises a speaker 102 for outputting a received far-end user's signal x(k) 100 and a microphone 103 for converting a near-end user's signal s(k) 130 and a noise signal n(k) 140 into an electrical voice signal. In addition, the microphone 103 receives an output signal y(k) 101 of the speaker 102 for the far-end user's signal x(k) 100, together with the near-end user's signal s(k) 130 and the noise signal n(k) 140.

An output signal d(k) 104 of the microphone 103 is input to a double talk detector 106. The double talk detector 106 determines whether the far-end user's signal x(k) 100 is detected, and establishes an output path according to the determination result. The double talk detector 106 outputs the input signal d(k) 104 to an AEC 116 in the presence of the far-end user's signal x(k) 100. However, in the absence of the far-end user's signal x(k) 100, the double talk detector 106 outputs the input signal d(k) 104 to a switch 112. In this way, the double talk detector 106 outputs the input signal d(k) 104 through different paths, in order to cancel an echo component of the output signal y(k) 101 of the speaker 102 for the far-end user's signal x(k) 100 through the AEC 116 when double talk is detected.

The AEC 116 which uses the NLMS algorithm receives the far-end user's signal x(k) 100, and cancels the output signal y(k) 101 for the far-end user's signal x(k) 100 received through the acoustic echo path from the input signal d(k) 104 received from the double talk detector 106. Therefore, in the presence of the far-end user's signal x(k) 100, the AEC 116 outputs a residual echo signal e(k) 120 obtained by subtracting the far-end user's signal x(k) 100 from the input signal d(k) 104.

The switch 112 performs a switching operation to input one of the signal output from the AEC 116 and the signal output from double talk detector 106 to a vocoder 160. Specifically, the switch 112 connects the AEC 116 to the vocoder 160 in the presence of the output of the AEC 116, and connects the double talk detector 106 to the vocoder 160 in the absence of the output of the AEC 116 and in the presence of the output of the double talk detector 106.

In FIG. 1, a vocoder is divided into the vocoder 160 for processing transmission signals and a vocoder 161 for processing reception signals. In practice, however, the vocoder can be implemented with a single chip in the mobile terminal such that it can process both the transmission signals and the reception signals.

FIG. 2 is a diagram illustrating a simplified model for a description of an operation of the AEC 116 illustrated in FIG. 1. With reference to FIG. 2, a detailed description will now be made of an operation and a signal flow of the AEC 116.

For simplicity, FIG. 2 shows a speaker 102 for receiving a far-end user's signal x(k) 100, a microphone 103 for converting a near-end user's signal s(k) 130, a background noise signal n(k) 140 and an echo component y(k) 101 of the far-end user's signal x(k) 100 into an electrical signal d(k) 104, an AEC 116, and an adder 206 for calculating a difference between an output signal of the AEC 116 and an output signal of the microphone 103.

The speaker 102 outputs the received far-end user's signal x(k) 100. The microphone 103 receives the near-end user's signal s(k) 130, the background noise n(k) 140 surrounding the near-end user, and the echo signal y(k) 101 of the far-end user's signal x(k) 100, which is output from the speaker 102 and passes through an acoustic echo path. The microphone 103 combines the received signals, and converts the combined signal into an electrical signal d(k) 104.

The AEC 116 uses an NLMS algorithm-based adaptive filter. The AEC 116 generates an estimated echo signal y(k) 204 from the far-end user's signal x(k) 100, and outputs the estimated echo signal y(k) 204 to the adder 206. The adder 206 calculates a residual echo signal e(k) 120 by subtracting the estimated echo signal y(k) 204 from the electrical signal d(k) 104 output from the microphone 103, and outputs the residual echo signal e(k) 120 to a vocoder (not shown) 160, and also outputs the residual echo signal e(k) 120 to the AEC 116 to control an estimation capability of the adaptive filter.

The adder 206 outputs the residual echo signal e(k) 120 by subtracting the estimated echo signal y(k) 204 from the signal d(k) 104 output from the microphone 103. The signal d(k) 104 output from the microphone 103 can be expressed as
d(k)=s(k)+n(k)+y(k) (1)

The AEC 116 generates the estimated echo signal ŷ(k) 204 by using the far-end user's signal x(k) 100 as a reference input signal in accordance with Equation (2) below.
ŷ(k)=X^{T}(k)W(k) (2)

In Equation (2), X^{T}(k) denotes a transpose matrix of the far-end user's signal x(k) 100, and W(k) denotes a coefficient of the adaptive filter. The AEC 116 which uses the adaptive algorithm must estimate an echo component and adjust the filter coefficient every time such that a difference, or an error, between the estimated echo component ŷ(k) 204 and the actual echo component becomes small.

The adder 206 calculates an average power of the residual echo signal e(k) 120 by subtracting the ŷ(k) 204 calculated by using Equation (2) from the d(k) 104 in accordance with Equation (3) below.
e(k)=d(k)−ŷ(k) (3)

Using Equation (4) and Equation (5) below, a new echo component is estimated by calculating a coefficient W(k) of an adaptive filter of the AEC 116 which uses the residual echo signal e(k) 120 calculated by Equation (3).

$$\begin{matrix}W ( k + 1 ) = W ( k ) \frac{μ X ( k ) e ( k )}{{\vert X ( k ) \vert}^{2}} & ( 4 ) \\ X ( k ) = [ x ( k ) , x ( k - 1 ) , … , x ( k - n ) ] & ( 5 )\end{matrix}$$

In Equation (4), W(k+1) denotes an adaptive filter coefficient updated to estimate a new echo component, and μ denotes a value determined taking into account the type of the mobile terminal like the slide type and the folder type. Equation (5) expresses, as a column matrix, values of the far-end user's signal x(k) 100 with which the adaptive filter estimates a direction signal. In Equation (5), ‘n’ denotes the number of taps of the adaptive filter, which is a length of a path for the echo signal.

The conventional AEC applied to the mobile terminal shows an excellent echo cancellation capability in a normal call with a short acoustic echo path. However, when the mobile terminal operates in the video conference mode or the speaker phone mode, a length of the acoustic echo path is increased. The increase in length of the acoustic echo path increases a length ‘n’ of the adaptive filter. As a result, it can be noted from Equation (2) and Equation (4) that the echo component is calculated by estimating the longer time delay, increasing the total calculation.

When the mobile terminal enters the speaker phone mode, it increases in both volume of the speaker and sensitivity of the microphone. A far-end user's voice output from the speaker is directly input to the high-sensitivity microphone after being reflected by the wall or objects, or directly input to the high-sensitivity microphone, and then transmitted to the far-end user. In this case, the path of the echo signals reflected by the wall or objects increases. In order to cancel the echo signals, the number of taps of the adaptive filter of the NLMS algorithm must be increased.

Generally, the AEC is so designed as to show the optimal performance at a path delay of about 64 ms to 126 ms, and the number of taps of the adaptive filter becomes 512 to 1024 for a digital signal having a sample frequency of 8 KHz. However, the mobile terminal can hardly perform the foregoing complex calculation due to its limitation in memory and battery capacity.

### SUMMARY OF THE INVENTION

It is, therefore, an object of the present invention to provide an acoustic echo cancellation (AEC) apparatus and method adaptive to each mode without an increase in calculation in a mobile communication system.

It is another object of the present invention to provide an AEC apparatus and method for efficiently canceling echo component varying depending on a distance from a far-end user in a mobile terminal for a mobile communication system.

It is further another object of the present invention to provide an AEC apparatus and method for adaptively canceling an echo component without an increase in number of taps of an adaptive filter in a mobile terminal for a mobile communication system.

It is yet another object of the present invention to provide an AEC apparatus and method for effectively canceling an echo component without an increase in capacity of a memory in a mobile terminal for a mobile communication system.

According to one aspect of the present invention, a method is provided for canceling an acoustic echo in a mobile terminal comprising an acoustic echo canceller (AEC) for canceling an echo signal from a received far-end user's signal. The method comprises the steps of upon detecting double talk, lowpass-filtering an output signal and down-sampling the lowpass-filtered signal, estimating an echo signal by using the far-end user's signal, and outputting a residual echo signal by canceling the estimated echo signal from the down-sampled signal, and up-sampling the residual echo signal by zero padding, and lowpass-filtering the up-sampled signal.

According to one aspect of the present invention, an acoustic echo cancellation apparatus in a mobile terminal is provided. The apparatus comprises a double talk detector for determining whether an input signal from a microphone and a far-end user's signal coexist, for outputting the signals through a first path if the signals coexist, and for outputting the signals through a second path if the signals do no coexist, a down-sampler connected to an output of the first path, for decreasing a sampling rate of an input signal, an acoustic echo canceller (AEC) for receiving an output signal of the down-sampler and the far-end user's signal, estimating an echo signal of the far-end user's signal, and canceling the estimated echo signal from the far-end user's signal, an up-sampler for up-sampling an output of the AEC by zero padding, and a switch for connecting one of an output of the up-sampler and an output of the second path to a vocoder.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional acoustic echo canceller (AEC) apparatus included in a mobile terminal;

FIG. 2 is a block diagram illustrating the AEC of FIG. 1;

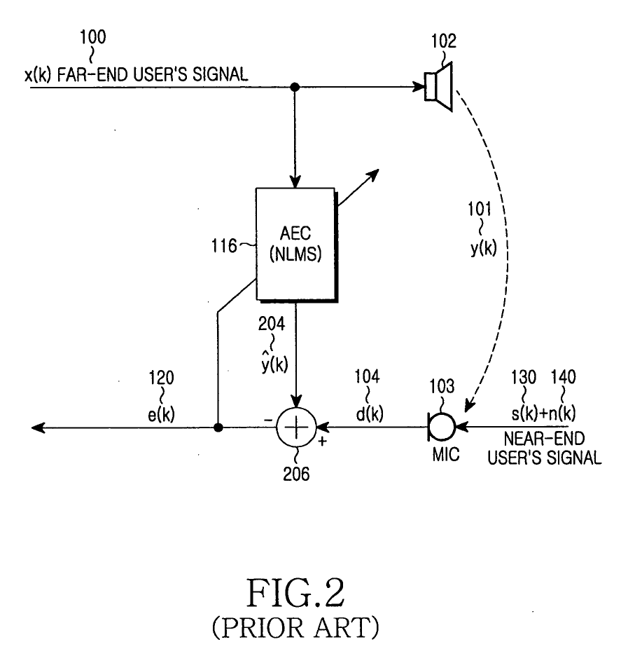

FIG. 3 is a block diagram of an AEC apparatus included in a mobile terminal according to an exemplary embodiment of the present invention;

FIG. 4 is a flowchart illustrating a process of canceling an echo signal in a mobile terminal according to an exemplary embodiment of the present invention; and

FIGS. 5A to 5D are diagrams illustrating a comparison between an exemplary embodiment of the present invention and a prior art in terms of AEC capability.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the accompanying drawings. In the following description, a detailed description of known functions and configurations incorporated herein has been omitted for clarity and conciseness.

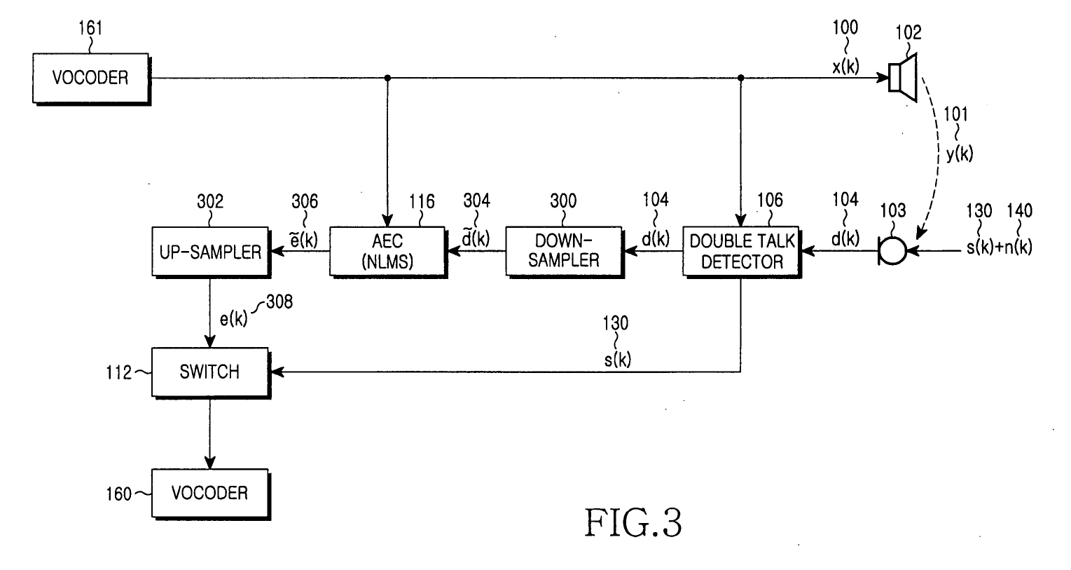

FIG. 3 is a block diagram of an acoustic echo canceller (AEC) apparatus and its peripheral circuit according to an exemplary embodiment of the present invention. With reference to FIG. 3, a detailed description will now be made of a structure and operation of an AEC apparatus and its peripheral circuit according to an exemplary embodiment of the present invention.

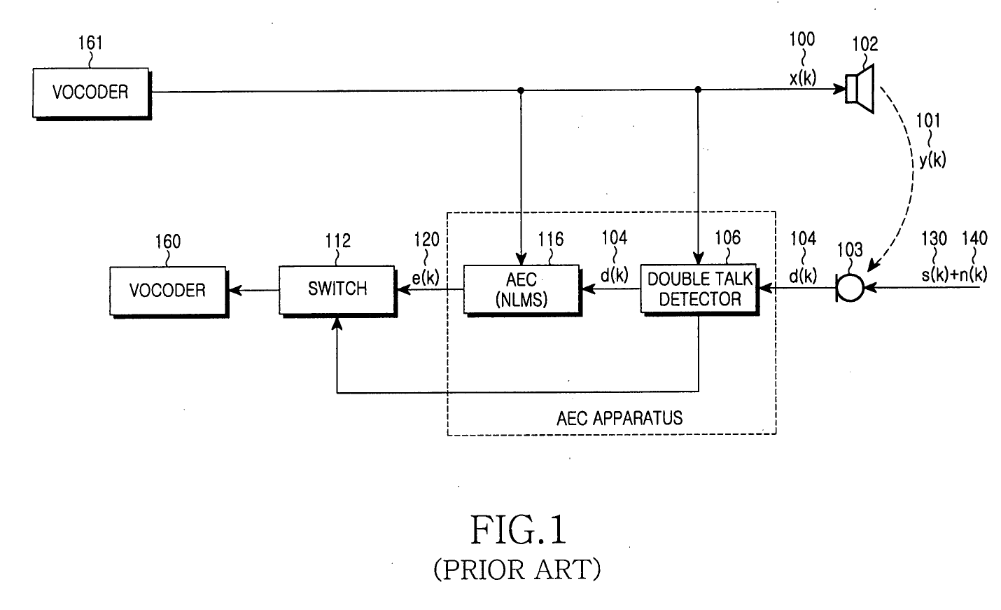

The peripheral circuit comprises a speaker 102 for outputting a received far-end user's signal x(k) 100 and a microphone 103 for converting a near-end user's signal s(k) 130 and a noise signal n(k) 140 into an electrical voice signal. In addition, the microphone 103 receives an output echo signal y(k) 101 of the speaker 102 for the far-end user's signal x(k) 100, together with the near-end user's signal s(k) 130 and the noise signal n(k) 140. Compared with the conventional AEC apparatus of FIG. 1, the new AEC apparatus of FIG. 3 further comprises a down-sampler 300 and an up-sampler 302 arranged in a pre-stage and a post-stage of an AEC 116.

An output signal d(k) 104 of the microphone 103 is input to a double talk detector 106. The double talk detector 106 determines whether the far-end user's signal x(k) 100 is detected, and establishes an output path according to the determination result. The double talk detector 106 outputs the input signal d(k) 104 to the down-sampler 300 in the presence of the far-end user's signal x(k) 100, and outputs the input signal d(k) 104 to a switch 112 in the absence of the far-end user's signal x(k) 100.

The down-sampler 300 comprises therein a lowpass filtering part and a down-sampling part. The lowpass filtering part lowpass-filters a signal d(k) 104 received at the down-sampler 300 from the double talk detector 106. Thereafter, the down-sampling part down-samples the lowpass-filtered signal by using digital signal processing, and outputs a down-sampled signal \tilde{d}(k) 304, the amount of information of which is reduced, to the AEC 116.

The AEC 116 which uses the normalized least mean square (NLMS) algorithm receives the far-end user's signal x(k) 100, and cancels the output signal y(k) 101 for the far-end user's signal x(k) 100 received through the acoustic echo path from the down-sampled signal \tilde{d}(k) 304 received from the down-sampler 300. That is, the AEC 116 outputs a residual echo signal \tilde{e}(k) 306 by canceling the echo signal y(k) 101 of the far-end user's signal 100 from the down-sampled signal \tilde{d}(k) 304.

The down sampling widens a frequency domain by a down-sampling rate, generating an aliasing phenomenon. Therefore, the down-sampler 300 must perform filtering by using a lowpass filter in order to prevent the aliasing. A cutoff frequency of the lowpass filter can be calculated by using Equation (6) below.
W_{c}_{_{—}}_{down}=Fₛ/M (6)

In Equation (6), W_{c}_{_{—}}_{donw} denotes a cutoff frequency of the lowpass filter during down sampling, Fₛ denotes a sampling period of the signal d(k) 104 input to the down-sampler 300, and M denotes a down-sampling interval. The down-sampler 300 outputs the down-sampled signal \tilde{d}(k) 304 to the AEC 116.

By decreasing the sampling rate through the down sampling and then implementing the NLMS algorithm at the decreased sampling rate, it is possible to decrease the delay by a value determined by dividing the number of taps of the conventional adaptive filter by the number of the down samplings.

The AEC 116 using a NLMS algorithm-based adaptive filter receives the far-end user's signal x(k) 100, and cancels the echo signal y(k) 101 of the far-end user's signal x(k) 100 received through the acoustic echo path from the down-sampled signal d(k) 304 received from the down-sampler 300.

As described in the prior art section, upon receiving the down-sampled signal \tilde{d}(k) 304, the AEC 116 outputs the residual echo signal \tilde{e}(k) 306 by using Equation (1) to Equation (5).

Next, the up-sampler 302 restores the residual echo signal \tilde{e}(k) 306 received from the AEC 116 into its original signal by zero padding, and lowpass-filters the restored signal to cancel the high-frequency component. That is, the up-sampler 302 also comprises an up-sampling part and a lowpass filtering part. Compared with the down-sampler 300, the up-sampler 302 performs up sampling and thereafter, performs lowpass filtering to remove the high-frequency component. In this manner, the up-sampler 302 outputs a residual echo signal e(k) 308. The up-sampler 302 performs up sampling by zero padding. The term “zero padding” refers to a process of inserting zero (0) between samples to obtain a desired sampling rate, in order to restore the sampling rate decreased in the down-sampler 300.

As described above, if the up-sampler 302 up-samples the down-sampled information by using zero padding, the frequency domain decreases by the sampling rate, generating aliasing. Therefore, the up-sampler 302 should also perform filtering with a lowpass filter in order to prevent the aliasing. A cutoff frequency of the lowpass filter can be calculated by using Equation (7) below.
W_{c}_{_{—}}ᵤₚ=Fₛ/L (7)

In Equation (7), W_{c}ᵤₚ denotes a cutoff frequency of the lowpass filter during up sampling, Fₛ denotes a sampling period of the residual echo signal \tilde{e}(k) 306 input to the up-sampler 302, and L denotes an up-sampling interval. The up-sampler 302 generates the residual echo signal e(k) 308 by restoring the sampling frequency by dividing the sampling period by the up-sampling interval in accordance with Equation (7).

The zero-padded signal is input to the switch 112. The switch 112 performs a switching operation to input one of the signal output from the up-sampler 302 and the signal output from double talk detector 106 to a vocoder 160. Specifically, the switch 112 connects the up-sampler 302 to the vocoder 160 in the presence of the output of the up-sampler 302, and connects the double talk detector 106 to the vocoder 160 in the absence of the output of the up-sampler 302 and in the presence of the output of the double talk detector 106.

In FIG. 3, a vocoder is divided into the vocoder 160 for processing transmission signals and a vocoder 161 for processing reception signals. In practice, however, the vocoder can be implemented with a single chip in the mobile terminal such that it can process both the transmission signals and the reception signals.

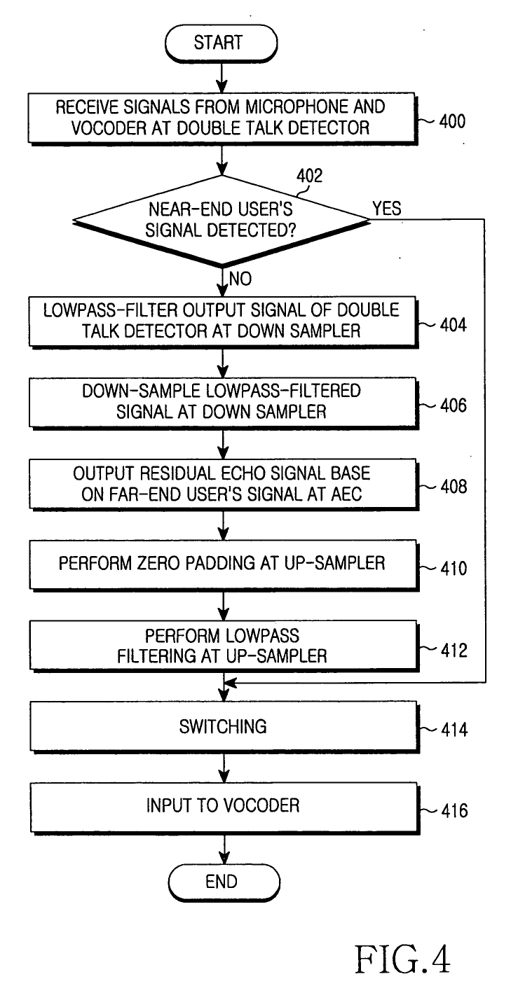

FIG. 4 is a flowchart illustrating a process of canceling an echo signal in a mobile terminal according to an exemplary embodiment of the present invention. With reference to FIG. 4, a detailed description will now be made of an operation of canceling an echo signal.

In step 400, a double talk detector 106 of the mobile terminal receives a signal d(k) 104 output from a microphone 103 and a far-end user's signal x(k) 100 output from a vocoder 161.

In step 402, the double talk detector 106 determines the presence/absence of a near-end user's signal s(k) 130 according to the presence/absence of the far-end user's signal s(k) 100. In the presence of the near-end user's signal s(k) 130, the double talk detector 106 proceeds to step 414 where it transmits the near-end user's signal s(k) 130 to a switch 112. However, in the absence of the near-end user's signal s(k) 130, the double talk detector 106 proceeds to step 404 where it outputs the signal d(k) 104 to a down-sampler 300.

In step 404, the down-sampler 300 lowpass-filters the input signal d(k) 104 in order to prevent aliasing. In step 406, the down-sampler 300 down-samples the lowpass-filtered signal to decrease a sampling rate, and outputs the down-sampled signal to an AEC 116.

In step 408, the AEC 116 generates a residual echo signal \tilde{e}(k) 306 by canceling an echo component from the far-end user's signal x(k) 100. In step 410, an up-sampler 302 performs zero padding on the residual echo signal \tilde{e}(k) 306 to increase a sampling rate of the residual echo signal whose a sampling rate was reduced due to the down sampling. In step 412, the up-sampler 302 lowpass-filters the zero-padded signal by using a lowpass filter comprised therein to prevent the aliasing caused by the increase in the sampling rate, and outputs the lowpass-filtered signal e(k) 308 to the switch 112.

In step 414, the switch 112 selects one of the signal output from the up-sampler 302 and the signal output from the double talk detector 106, and outputs the selected signal to a vocoder 160. In step 416, the vocoder 160 encodes the input signal.

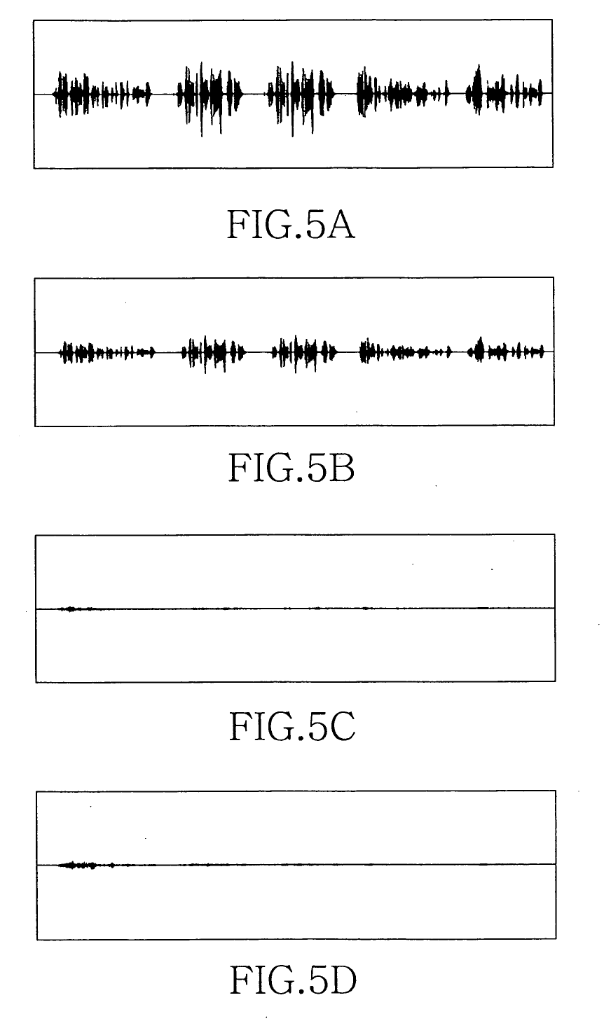

With reference to FIGS. 5A to 5D, a description will now be made of simulation results for the AEC apparatus according to an exemplary embodiment of the present invention. FIGS. 5A to 5D are diagrams illustrating simulation results for the novel AEC apparatus and the conventional AEC apparatus based on a far-end user's signal and a near-end user's signal.

FIG. 5A illustrates a far-end user's signal x(k) 100, FIG. 5B illustrates a near-end user's signal s(k) 130, FIG. 5C illustrates a residual echo signal e(k) 300 output from the novel AEC apparatus, and FIG. 5D illustrates a residual echo signal output from the conventional NLMS algorithm-based AEC apparatus.

FIGS. 5A to 5D show a comparison between the residual echo signal output from the novel AEC apparatus and the residual echo signal output from the conventional NLMS-based AEC apparatus. Although the conventional AEC apparatus included in the mobile terminal is inferior to the conventional AEC apparatus included in the fixed terminal in terms of an AEC capability for an echo signal with a long echo path, the novel AEC apparatus included in the mobile terminal is similar or superior to the novel AEC apparatus included in the fixed terminal in terms of the AEC capability.

It is shown in FIGS. 5A to 5D that the novel AEC apparatus is superior in performance to the conventional NLMS algorithm-based AEC apparatus. In addition, Table 1 below shows that the novel AEC apparatus is superior to the conventional NLMS algorithm-based AEC apparatus in terms of calculation and memory efficiency.

TABLE 1

| | Average | Total | | Multi- | |
|---|---|---|---|---|---|
| | Power | Power | Addition | plication | Memory |
| NLMS | −56.47 dB | −51.51 dB | 2n | 2n | n |
| Inven- | −57.52 dB | −52.99 dB | 2n/M + p/M | 2n/M + p/M | n/M + p |
| tion | | | | | |

In Table 1, ‘n’ denotes the number of taps of an adaptive filter, ‘p’ denotes a length of a filter coefficient used for a change in sampling frequency, and M denotes a decimation coefficient. It can be noted from Table 1 that the novel AEC apparatus is similar to the conventional NLMS algorithm-based AEC apparatus in terms of the residual echo signal e(k) output therefrom, but the novel AEC apparatus is superior to the conventional NLMS algorithm-based AEC apparatus in terms of the calculation and memory efficiency.

As can be understood from the foregoing description, exemplary embodiments of the present invention can improve AEC performance of the conventional AEC apparatus that cannot efficiently cancel the echo signal due to an increase in echo path in a video conference mode or a speaker phone mode of the mobile terminal that is limited in calculation and memory efficiency compared with a fixed terminal.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for canceling an acoustic echo in a mobile terminal comprising an acoustic echo canceller (AEC) for canceling an echo signal from a received far-end user's signal, the method comprising the steps of:
upon detecting double talk, lowpass-filtering an output signal and down-sampling the lowpass-filtered signal;
estimating an echo signal using the far-end user's signal;
outputting a residual echo signal by canceling the estimated echo signal from the down-sampled signal; and
up-sampling the residual echo signal by zero padding, and lowpass-filtering the up-sampled signal.

2. The method of claim 1, wherein the down sampling is performed by using an equation comprising:
W_{c}_{_{—}}_{donw}=Fₛ/M
where W_{c}_{_{—}}_{donw} denotes a cutoff frequency of a lowpass filter during the down sampling, Fₛ denotes a sampling period of the down-sampled signal, and M denotes a down-sampling interval.

3. The method of claim 1, wherein the up sampling is performed by using an equation comprising:
W_{c}_{_{—}}ᵤₚ=Fₛ/L
where W_{c}_{_{—}}ᵤₚ denotes a cutoff frequency of a lowpass filter during the up sampling, Fₛ denotes a sampling period of the up-sampled signal, and L denotes an up-sampling interval.

4. An acoustic echo cancellation apparatus in a mobile terminal, comprising:
a double talk detector for determining whether an input signal from a microphone and a far-end user's signal coexist, outputting the signals through a first path if the signals coexist, and outputting the signals through a second path if the signals do no coexist;
a down-sampler connected to an output of the first path, for decreasing a sampling rate of an input signal;
an acoustic echo canceller (AEC) for receiving an output signal of the down-sampler and the far-end user's signal, estimating an echo signal of the far-end user's signal, and canceling the estimated echo signal from the far-end user's signal;
an up-sampler for up-sampling an output of the AEC by zero padding; and
a switch for connecting one of an output of the up-sampler and an output of the second path to a vocoder.

5. The acoustic echo cancellation apparatus of claim 4, wherein the down-sampler comprises a lowpass filter for lowpass-filtering an input signal.

6. The acoustic echo cancellation apparatus of claim 4, wherein the up-sampler comprises a lowpass filter for lowpass-filtering the up-sampled signal.

7. The acoustic echo cancellation apparatus of claim 4, wherein the down-sampler performs the down sampling by using an equation comprising:
W_{c}_{_{—}}_{donw}=Fₛ/M
where W_{c}_{_{—}}_{donw} denotes a cutoff frequency of a lowpass filter during the down sampling, Fₛ denotes a sampling period of the down-sampled signal, and M denotes a down-sampling interval.

8. The acoustic echo cancellation apparatus of claim 4, wherein the up-sampler performs the up sampling by using an equation comprising:
W_{c}_{_{—}}ᵤₚ=Fₛ/L
where W_{c}_{_{—}}ᵤₚ denotes a cutoff frequency of a lowpass filter during the up sampling, Fₛ denotes a sampling period of the up-sampled signal, and L denotes an up-sampling interval.
